(19) United States
(12) Patent Application Publication
(10) Pub. No.: US 2025/0048355 A1
(43) Pub. Date: Feb. 6, 2025

(54) ELECTRONIC DEVICE AND METHOD FOR WIRELESS COMMUNICATION, AND COMPUTER READABLE STORAGE MEDIUM

(71) Applicant: Sony Group Corporation, Tokyo (JP)

(72) Inventors: Jin XU, Beijing (CN); Yuyan PENG, Beijing (CN); Jianfei CAO, Beijing (CN)

(73) Assignee: Sony Group Corporation, Tokyo (JP)

(21) Appl. No.: 18/706,751

(22) PCT Filed: Nov. 4, 2022
(86) PCT No.: PCT/CN2022/129810

§ 371 Date: May 2, 2024

(30) Foreign Application Priority Data
Nov. 10, 2021 (CN) 202111326533.5

(51) Int. Cl. H04W 72/1268; H04L 5/00

(52) U.S. Cl. CPC H04W 72/1268; H04L 5/0051

(57) ABSTRACT

The present disclosure provides an electronic device and method for wireless communication, and a computer readable storage medium. The electronic device comprises a processing circuit configured to: receive configuration information set, by a network side device which provides a service for an apparatus related to the electronic device, for each of a plurality of antenna panels of the electronic device, wherein the configuration information is used for establishing an association between each antenna panel and a downlink reference signal, so that the network side device selects, on the basis of the association, an antenna panel for uplink transmission from the plurality of antenna panels.

### FIELD OF THE INVENTION

This application claims the priority of Chinese Patent Application No. 202111326533.5, entitled “ELECTRONIC DEVICE AND METHOD FOR WIRELESS COMMUNICATION, AND COMPUTER READABLE STORAGE MEDIUM”, filed with the Chinese Patent Office on Nov. 10, 2021, the entire contents of which are incorporated herein by reference.

### TECHNICAL FIELD

The present disclosure relates to the technical field of wireless communications, particularly to an electronic apparatus and method for wireless communications, and a computer readable storage medium, and more particularly, to identifying a plurality of antenna panels of user equipment to select an antenna panel for uplink transmission.

### BACKGROUND ART

To perform uplink transmission, network side equipment such as a base station needs to select an antenna panel for uplink transmission from a plurality of antenna panels of user equipment (UE). In the existing technology, there are two solutions for identifying UE antenna panels. Solution 1 is to identify antenna panels using IDs of the antenna panels. Solution 2 is to identify antenna panels using physical characteristics of the antenna panels. However, reporting an ID of an antenna panel by a UE to a base station will expose antenna array arrangement information and the like of the antennal panel. As for solution 2, it is applicable only to heterogeneous antennas for which physical characteristics of two antenna panels are not completely the same.

### SUMMARY OF THE INVENTION

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to one aspect of the present disclosure, there is provided an electronic apparatus for wireless communications, comprising processing circuitry configured to: receive configuration information set by network side equipment serving a device related to the electronic apparatus for each of a plurality of antenna panels of the electronic apparatus, wherein the configuration information is used to establish an association between each antenna panel and a downlink reference signal, for the network side equipment to select an antenna panel for uplink transmission from the plurality of antenna panels based on the association

In an embodiment according to the present disclosure, an electronic apparatus can identify antenna panels based on configuration information set by network side equipment for each antenna panel of the electronic apparatus, thereby not exposing an implementation manner such as array arrangement and the like of the antenna panels, which is applicable not only to heterogeneous antennas but also to homogeneous antennas.

According to another aspect of the present disclosure, there is provided an electronic apparatus for wireless communications, comprising processing circuitry configured to: set, for user equipment within coverage of a device related to the electronic apparatus, configuration information for each of a plurality of antenna panels of the user equipment, wherein the configuration information is used to establish an association between each antenna panel and a downlink reference signal, for the electronic apparatus to select an antenna panel for uplink transmission from the plurality of antenna panels based on the association.

In an embodiment according to the present disclosure, antenna panels can be identified from configuration information set by an electronic apparatus for each antenna panel of user equipment, while not exposing an implementation manner such as array arrangement and the like of the antenna panels, which is applicable not only to heterogeneous antennas but also to homogeneous antennas.

According to another aspect of the present disclosure, there is provided a method for wireless communications, comprising: receiving configuration information set by network side equipment serving a device related to the electronic apparatus for each of a plurality of antenna panels of the electronic apparatus, wherein the configuration information is used to establish an association between each antenna panel and a downlink reference signal, for the network side equipment to select an antenna panel for uplink transmission from the plurality of antenna panels based on the association.

According to another aspect of the present disclosure, there is provided a method for wireless communications, comprising: setting, for user equipment within coverage of network side equipment, configuration information for each of a plurality of antenna panels of the user equipment, wherein the configuration information is used to establish an association between each antenna panel and a downlink reference signal, for the network side equipment to select an antenna panel for uplink transmission from the plurality of antenna panels based on the association.

According to other aspects of the present invention, there are further provided a computer program code and a computer program product for implementing the above-mentioned methods for wireless communications, as well as a computer readable storage medium on which the computer program code for implementing the above-mentioned methods for wireless communications is recorded.

These and other advantages of the present invention will be more apparent through the following detailed description of preferred embodiments of the present invention in conjunction with the accompanying drawings.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, these figures only describe typical examples of the present invention, and should not be regarded as limitations to the scope of the present invention. In the accompanying drawings:

FIG. 1 shows a block diagram of functional modules of an electronic apparatus for wireless communications according to an embodiment of the present disclosure;

FIG. 2 is a diagram showing an example of configuration information set for each antenna panel according to the embodiment of the present disclosure;

FIG. 3 is a diagram showing an example in which configuration information is selected from a configuration information pool set for a plurality of antenna panels according to the embodiment of the present disclosure;

FIG. 4 is a signaling interaction diagram showing selection of an antenna panel for uplink transmission from a plurality of antenna panels based on configuration information which is performed between the electronic apparatus according to the embodiment of the present disclosure and network side equipment;

FIG. 5 is a diagram showing reporting power margin for a plurality of antenna panels by the electronic apparatus according to the embodiment of the present disclosure;

FIG. 6 shows a diagram including uplink timing advance commands of a plurality of antenna panels which are received by the electronic apparatus according to the embodiment of the present disclosure from network side equipment;

FIG. 7 shows a block diagram of functional modules of an electronic apparatus for wireless communications according to another embodiment of the present disclosure;

FIG. 8 shows a flowchart of a method for wireless communications according to an embodiment of the present disclosure;

FIG. 9 shows a flowchart of a method for wireless communications according to another embodiment of the present disclosure;

FIG. 10 is a block diagram showing a first example of a schematic configuration of an eNB or gNB to which the technology of the present disclosure can be applied;

FIG. 11 is a block diagram showing a second example of a schematic configuration of an eNB or gNB to which the technology of the present disclosure can be applied;

FIG. 12 is a block diagram showing an example of a schematic configuration of a smart phone to which the technology of the present disclosure can be applied;

FIG. 13 is a block diagram showing an example of a schematic configuration of automobile navigation equipment to which the technology of the present disclosure can be applied;

FIG. 14 is a block diagram of an exemplary structure of a universal personal computer in which the methods and/or apparatuses and/or systems according to the embodiments of the present invention can be implemented.

### DETAILED DESCRIPTION OF THE EMBODIMENTS

Hereinafter, exemplary embodiments of the present disclosure will be described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly will vary as embodiments are different. In addition, it should also be appreciated that, although developing work may be very complicated and time-consuming, such developing work is only routine tasks for those skilled in the art benefiting from the present disclosure.

It should also be noted herein that, to avoid the present invention from being obscured due to unnecessary details, only those apparatus structures and/or processing steps closely related to the solution according to the present invention are shown in the accompanying drawings, while omitting other details not closely related to the present invention.

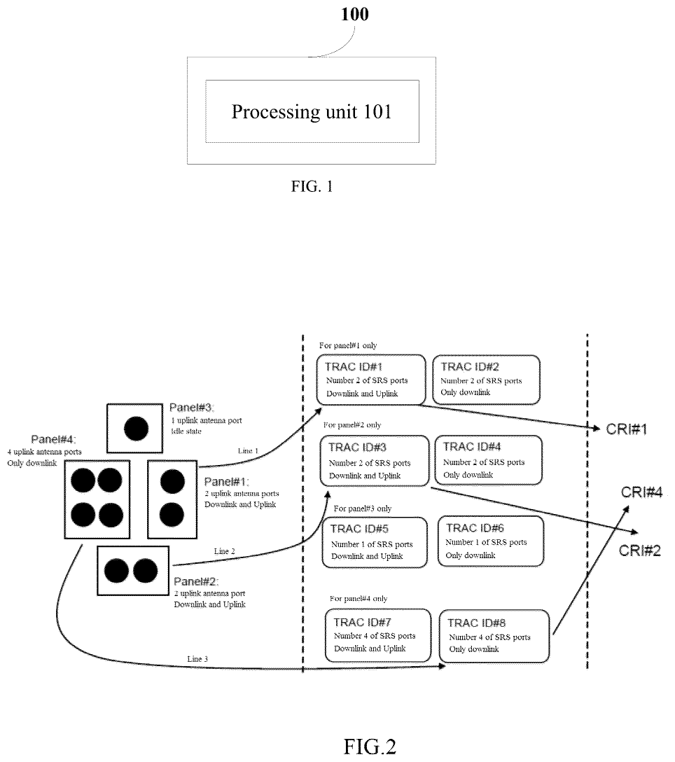

FIG. 1 shows a block diagram of functional modules of an electronic apparatus for wireless communications according to an embodiment of the present disclosure.

As shown in FIG. 1, an electronic apparatus 100 comprises: a processing unit 101, which may receive configuration information set by network side equipment serving a device related to the electronic apparatus for each of a plurality of antenna panels of the electronic apparatus 100, wherein the configuration information is used to establish an association between each antenna panel and a downlink reference signal, for the network side equipment to select an antenna panel for uplink transmission from the plurality of antenna panels based on the association.

Wherein, the processing unit 101 may be implemented by one or more processing circuitries which may be implemented as, for example, a chip.

The electronic apparatus 100 may serve as an apparatus in a wireless communication system. Specifically, the electronic apparatus 100 may be arranged on a user equipment (UE) side or may be communicatively connected to user equipment, for example. In a case where the electronic apparatus 100 is arranged on a user equipment side or is communicatively connected to user equipment, the device related to the electronic equipment 100 may be the user equipment. Here, it should also be noted that, the electronic apparatus 100 may be implemented either at chip level or at device level. For example, the electronic apparatus 100 may work as user equipment itself, and may also include external devices such as a memory, a transceiver (not shown in the figure) and the like. The memory may be used to store programs and related data information that the user equipment needs to execute in order to implement various functions. The transceiver may include one or more communication interfaces to support communication with different devices (e.g., a base station, other user equipment, etc.), and no implementation form of the transceiver is specifically limited here.

As an example, the network side equipment may be a base station, which may be, for example, an eNB or a gNB.

The wireless communication system according to the present disclosure may be a 5G NR (New Radio) communication system. Further, the wireless communication system according to the present disclosure may include a Non-terrestrial network (NTN). Optionally, the wireless communication system according to the present disclosure may also include a Terrestrial network (TN). In addition, those skilled in the art can understand that the wireless communication system according to the present disclosure may also be a 4G or 3G communication system.

When the electronic apparatus 100 is implemented at the device level (e.g., work as user equipment itself), each antenna panel may include one or more antenna units. Each antenna panel may have independent transceiver circuitry, and thus may form receive or transmit beams independently of each other. The individual antenna panels may have the same or different antenna array dimensions.

When the electronic apparatus 100 is implemented at the chip level, the functions of each antenna panel including one or more antenna units as described above may be implemented using a chip.

To perform uplink transmission, the network side equipment needs to select an antenna panel for uplink transmission from a plurality of antenna panels of the electronic apparatus 100. Since configuration information can identify antenna panels, the configuration information may be used to establish an association between each antenna panel and a downlink reference signal, for the network side equipment to select an antenna panel for uplink transmission from the plurality of antenna panels based on the association. In the following, for convenience, the configuration information is sometimes abbreviated as TRAC (Transmission/Reception Antenna Configuration).

In the embodiment according to the present disclosure, the electronic apparatus 100 can identify antenna panels based on configuration information set by the network side equipment for each antenna panel of the electronic apparatus 100, thereby not exposing an implementation manner such as array arrangement and the like of the antenna panels, which is applicable not only to heterogeneous antennas but also to homogeneous antennas.

As an example, the processing unit 101 may be configured to receive the configuration information from the network side equipment through radio resource control (RRC) signaling. Those skilled in the art can think of other ways of receiving the configuration information from the network side equipment, which will not be repeatedly described here.

As an example, the configuration information includes configuration information ID, the number of SRS ports of the antenna panel capable of emitting a sounding reference signal SRS, a type of coherent transmission between the SRS ports, and a working state of the antenna panel. In the following, the configuration information ID is sometimes abbreviated as TRAC ID.

As an example, the type of coherent transmission between the SRS ports includes one of non-coherent transmission, partially-coherent transmission, and fully-coherent transmission.

For example, examples of partially-coherent transmission between the SRS ports are given below. In a case where the number of the SRS ports is 4, the 4 SRS ports may be divided into two groups, which may be marked as (2,2) if each group has 2 coherent ports; and which may be marked as (3,1) if 3 SRS ports are coherent but are not coherent to the remaining 1 SRS port. In a case where the number of the SRS ports is 6, the 6 SRS ports may be divided into two groups, which may be marked as (3,3) or (2,4) or (1,5), for example, according to the number of coherent ports included in each group; or the 6 SRS ports may be divided into three groups, which may be marked as (2, 2, 2) if each group has 2 coherent ports. In a case where the number of the SRS ports is 8, the 8 SRS ports may be divided into two groups, which may be marked as (4,4), for example; or the 8 SRS ports may be divided into three groups, which may be marked as (2, 2, 4), for example; or the 8 SRS ports may be divided into four groups, which may be marked as (2, 2, 2, 2), for example.

As an example, the working state of the antenna panel includes one of a state of the antenna panel supporting only downlink reception, a state of the antenna panel supporting downlink reception and uplink transmission, and the antenna panel being in an idle state. The network side equipment may either set configuration information for an antenna panel in an idle state or not set configuration information for an antenna panel in an idle state.

As an example, the configuration information further includes latency information of the antenna panel.

As an example, the latency information includes activation latency and selection latency of the antenna panel. The activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and the selection latency includes latency generated between performing uplink scheduling by the network side equipment and performing uplink transmission by the electronic apparatus.

As an example, the configuration information further includes a flag indicating whether the antenna panel supports at least one of uplink timing advance, uplink Doppler shift pre-compensation, and uplink power control independent of other antenna panels. The antenna panel supporting uplink timing advance independent of other antenna panels refers to setting uplink timing advance for the antenna panel and other antenna panels respectively. The antenna panel supporting uplink Doppler frequency shift pre-compensation independent of other antenna panels refers to setting uplink Doppler frequency shift pre-compensation for the antenna panel and other antenna panels respectively. The antenna panel supporting uplink power control independent of other antenna panels refers to performing the uplink power control for the antenna panel and other antenna panels respectively.

As an example, the configuration information is set by the network side equipment for each antenna panel respectively, so that different antenna panels do not have the same configuration information. As an example, each antenna panel corresponds to at least one piece of configuration information, and each of the at least one piece of configuration information corresponds to one mode of the antenna panel respectively.

FIG. 2 is a diagram showing an example of configuration information set for each antenna panel according to the embodiment of the present disclosure. As an example, FIG. 2 shows four antenna panels panel #1-panel #4.

In FIG. 2, for simplicity, description is made by taking configuration information relating only to the number of SRS ports and working states of an antenna panel as an example. That is, an amount of configuration information of each antenna panel is determined only by the number of combinations of the number of SRS ports of the antenna panel and working states of the antenna panel. However, those skilled in the art may understand that, an amount of configuration information of each antenna panel may depend at least on the number of various combinations of the number of SRS ports, the type of coherent transmission between the SRS ports, and working states of the antenna panel. Further, an amount of configuration information of each antenna panel may also depend on the number of various combinations of latency information of the antenna panel, whether the antenna panel supports uplink timing advance independent of other antenna panels, whether the antenna panel supports uplink Doppler shift pre-compensation independent of other antenna panels, and whether the antenna panel supports uplink power control independent of other antenna panels.

The device related to the electronic apparatus 100, upon initial access to the network side equipment, sequentially reports modes (e.g., physical characteristics) of the panel #1-panel #4 to the network side equipment. For example, panel #1 has a mode 1 of having two SRS ports (which may also be called uplink antenna ports), with a working state being a state of the antenna panel supporting downlink reception and uplink transmission, and a mode 2 of having two SRS ports, with a working state being a state of the antenna panel supporting only downlink reception; panel #2 has a mode 1 of having two SRS ports, with a working state being a state of the antenna panel supporting downlink reception and uplink transmission, and a mode 2 of having two SRS ports, with a working state being a state of the antenna panel supporting only downlink reception; panel #3 has a mode 1 of having one SRS port, with a working state being a state of the antenna panel supporting downlink reception and uplink transmission, a mode 2 of having one SRS port, with a working state being a state of the antenna panel supporting only downlink reception, and a mode 3 of having one SRS port, with a working state being an idle state; panel #4 has a mode 1 of having four SRS ports, with a working state being a state of the antenna panel supporting downlink reception and uplink transmission, and a mode 2 of having four SRS ports, with a working state being a state of the antenna panel supporting only downlink reception.

The network side equipment sets, for the mode 1 of panel #1, configuration information including TRAC ID #1, the number 2 of SRS ports, and a working state being a state of the antenna panel supporting downlink reception and uplink transmission, and sets, for the mode 2 of panel #1, configuration information including TRAC ID #2, the number 2 of SRS ports, and a working statue being a state of the antenna panel supporting only downlink reception. In FIG. 2, for simplicity, “a working state being a state of the antenna panel supporting downlink reception and uplink transmission” is abbreviated as “downlink and uplink”, and “a working statue being a state of the antenna panel supporting only downlink reception” is abbreviated as “downlink only”.

The network side equipment sets, for the mode 1 of panel #2, configuration information including TRAC ID #3, the number 2 of SRS ports, and a working state being a state of the antenna panel supporting downlink reception and uplink transmission, and sets, for the mode 2 of panel #2, configuration information including TRAC ID #4, the number 2 of SRS ports, and a working statue being a state of the antenna panel supporting only downlink reception.

The network side equipment sets, for the mode 1 of panel #3, configuration information including TRAC ID #5, the number 1 of SRS ports, and a working state being a state of the antenna panel supporting downlink reception and uplink transmission, and sets, for the mode 2 of panel #3, configuration information including TRAC ID #6, the number 1 of SRS ports, and a working statue being a state of the antenna panel supporting only downlink reception. In FIG. 2, for simplicity, it is assumed that the network side equipment does not set configuration information for panel #3 whose working state is idle (that is, the network side equipment does not set configuration information for the mode 3 of panel #3). However, as described above, the network side equipment may set configuration information for panel #3 whose working state is idle.

The network side equipment sets, for the mode 1 of panel #4, configuration information including TRAC ID #7, the number 4 of SRS ports, and a working state being a state of the antenna panel supporting downlink reception and uplink transmission, and sets, for the mode 2 of panel #4, configuration information including TRAC ID #8, the number 4 of SRS ports, and a working statue being a state of the antenna panel supporting only downlink reception.

In FIG. 2, assuming that a current mode of panel #1 is the mode 1 of panel #1, then a configuration information ID of current configuration information of panel #1 is TRAC ID #1, as shown by line 1; assuming that a current mode of panel #2 is the mode 1 of panel #2, then a configuration information ID of current configuration information of panel #2 is TRAC ID #3, as shown by line 2; assuming that a current mode of panel #4 is the mode 2 of panel #4, then a configuration information ID of current configuration information of panel #4 is TRAC ID #8, as shown by line 3. Assuming that the current mode of panel #3 is the mode 3 of panel #3, then panel #3 has no corresponding configuration information since its working state is idle.

As can be known from the above description, each piece of configuration information is dedicated to a certain antenna panel, and different antenna panels do not have the same configuration information. For example, in FIG. 2, even if the current modes of panel #1 and panel #2 are the same, the configuration information IDs of panel #1 and panel #2 are different.

As an example, the configuration information is selected from a configuration information pool set by the network side equipment for the plurality of antenna panels, so that different antenna panels with the same mode share the same configuration information. As an example, each antenna panel corresponds to at least one piece of configuration information, and each of the at least one piece of configuration information corresponds to one mode of the antenna panel respectively.

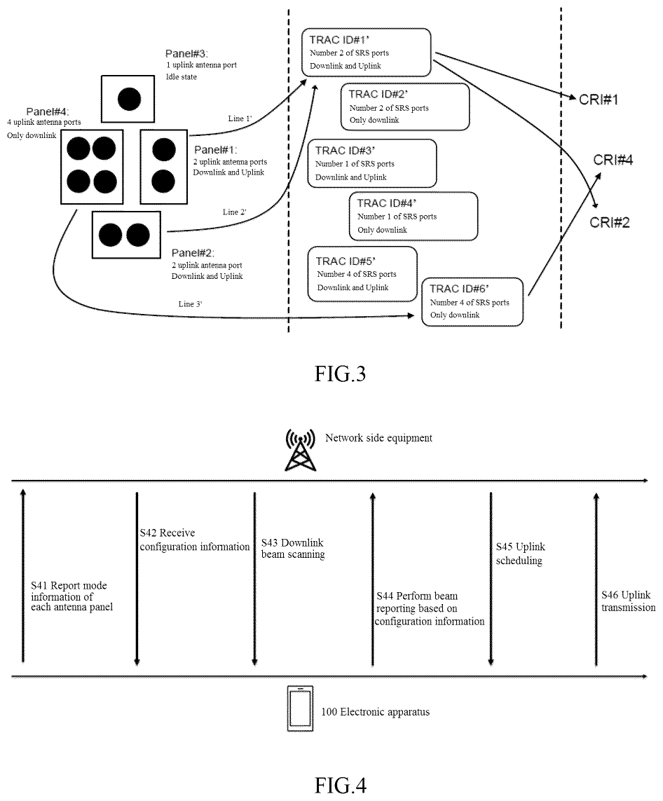

FIG. 3 is a diagram showing an example in which configuration information is selected from a configuration information pool set for a plurality of antenna panels according to the embodiment of the present disclosure. The four antenna panels panel #1-panel #4 as shown in FIG. 3 are the same as the four antenna panels panel #1-panel #4 as shown in FIG. 2, respectively.

For the modes (e.g., physical characteristics) of the panel #1-panel #4 which are reported by the device related to the electronic apparatus 100 to the network side equipment upon initial access to the network side equipment, the network side equipment counts modes of all the antenna panels, and sets configuration information for only modes which are not the same, respectively, thereby constituting a configuration information pool, for all the antenna panels to select configuration information matching their current modes from the configuration information pool according to the current modes of the antenna panels. It is assumed that the modes reported by the device related to the electronic apparatus 100 upon initial access to the network side equipment in FIG. 3 are the same as the reported modes as mentioned in FIG. 2.

The network side equipment sets, for the mode in which the number of SRS ports is 2 and a working state is a state of the antenna panel supporting downlink reception and uplink transmission, configuration information including TRAC ID #1′, the number 2 of SRS ports, and a working state being a state of the antenna panel supporting downlink reception and uplink transmission; sets, for the mode in which the number of SRS ports is 2 and a working state is a state of the antenna panel supporting only downlink reception, configuration information including TRAC ID #2′, the number 2 of the SRS ports, and a working state being a state of the antenna panel supporting only downlink reception; sets, for the mode in which the number of SRS ports is 1 and a working state is a state of the antenna panel supporting downlink reception and uplink transmission, configuration information including TRAC ID #3′, the number 1 of SRS ports, and a working state being a state of the antenna panel supporting downlink reception and uplink transmission; sets, for the mode in which the number of SRS ports is 1 and a working state is a state of the antenna panel supporting only downlink reception, configuration information including TRAC ID #4′, the number 1 of SRS ports, and a working state being a state of the antenna panel supporting only downlink reception; sets, for the mode in which the number of SRS ports is 4 and a working state is a state of the antenna panel supporting downlink reception and uplink transmission, configuration information including TRAC ID #5′, the number 4 of SRS ports, and a working state being a state of the antenna panel supporting downlink reception and uplink transmission; sets, for the mode in which the number of SRS ports is 4 and a working state is a state of the antenna panel supporting only downlink reception, configuration information including TRAC ID #6′, the number 4 of SRS ports, and a working state being a state of the antenna panel supporting only downlink reception, thus constituting a configuration information pool. In FIG. 3, for simplicity, “a working state being a state of the antenna panel supporting downlink reception and uplink transmission” is abbreviated as “downlink and uplink”, and “a working statue being a state of the antenna panel supporting only downlink reception” is abbreviated as “downlink only”. Further, in FIG. 3, for simplicity, it is assumed that the network side equipment does not set configuration information for the mode in which the antenna panel is in an idle state.

In FIG. 3, assuming that a current mode of panel #1 is having two SRS ports and a working state being a state of the antenna panel supporting downlink reception and uplink transmission, then a configuration information ID of current configuration information of panel #1 is TRAC ID #1′, as shown by line 1′; assuming that a current mode of panel #2 is having two SRS ports and a working state being a state of the antenna panel supporting downlink reception and uplink transmission, then a configuration information ID of the current configuration information of panel #2 is TRAC ID #1′, as shown by line 2′; assuming that a current mode of panel #4 is having four SRS ports and a working state being a state of the antenna panel supporting only supports downlink reception, then a configuration information ID of the current configuration information of panel #4 is TRAC ID #6′, as shown in line 3′. Assuming that a current mode of panel #3 is having one SRS port and a working state being an idle state, then panel #3 has no corresponding configuration information since its working state is an idle state.

As can be known from the above description, the configuration information pool may save resources for setting configuration information.

When a mode of an antenna panel changes, configuration information matching the mode of the antenna panel can be selected from the configuration information pool, as current configuration information of the antenna panel.

As can be known from the above, if different antenna panels have the same mode (e.g., physical characteristics), they use one piece of configuration information in common. For example, as shown in FIG. 3, since the current modes of panel #1 and panel #2 are the same, both the configuration information IDs of the configuration information of panel #1 and panel #2 are TRAC ID #1′.

As an example, the processing unit 101 may be configured to report, upon initial access of the device related to the electronic apparatus 100 to the network side equipment, mode information related to configuration information of each antenna panel to the network side equipment, for the network side equipment to set the configuration information based on the mode information. As described above in conjunction with FIG. 2 and FIG. 3, the network side equipment sets configuration information based on the mode information reported upon initial access of the device related to the electronic apparatus 100 to the network side equipment.

For example, the device related to the electronic apparatus 100 performs the above reporting in a capability reporting stage.

As an example, the mode information includes the number of SRS ports of the antenna panel, a type of coherent transmission between the SRS ports, and a working state of the antenna panel.

As an example, the type of coherent transmission between the SRS ports includes one of non-coherent transmission, partially-coherent transmission, and fully-coherent transmission.

As an example, the working state of the antenna panel includes one of a state of the antenna panel supporting only downlink reception, a state of the antenna panel supporting downlink reception and uplink transmission, and the antenna panel being in an idle state.

As an example, the mode information further includes latency information of the antenna panel.

As an example, the latency information includes activation latency and selection latency of the antenna panel, the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and the selection latency includes latency generated between performing uplink scheduling by the network side equipment and performing uplink transmission by the electronic apparatus.

As an example, the mode information further includes a flag indicating whether the antenna panel supports at least one of uplink timing advance, uplink Doppler shift pre-compensation, and uplink power control independent of other antenna panels.

As an example, the downlink reference signal includes a channel state information reference signal (CSI-RS) or a synchronization signal block (SSB).

As an example, the processing unit 101 may be configured to receive at least one downlink reference signal from the network side equipment, and the processing unit 101 may be configured to report, in beam reporting, a configuration information ID of configuration information of each antenna panel that is not in an idle state, a downlink reference signal indication of the antenna panel for the at least one downlink reference signal, and a channel quality measurement result of the antenna panel on a downlink reference signal corresponding to the downlink reference signal indication, to the network side equipment.

In a case where the downlink reference signal is a CSI-RS, the downlink reference signal indication is a channel state information resource indication (CRI). In a case where the downlink reference signal is an SSB, the downlink reference signal indication is a synchronization block resource indication (SSBRI). In the following, description will be made by taking the downlink reference signal being a CSI-RS as an example.

As an example, the channel quality measurement result includes reference signal receiving power (L1-RSRP) of layer 1 or signal-to-noise ratio (L1-SINR) of layer 1. In the following, description will be made by taking the channel quality measurement result being L1-RSRP as an example.

An example of selecting an antenna panel for uplink transmission from a plurality of antenna panels based on associations between antenna panels and downlink reference signals is described with reference to the example of setting configuration information for each antenna panel in FIG. 2.

Assuming that the electronic apparatus 100 has the antenna panels panel #1-panel #4 as shown in FIG. 2, as described in conjunction with FIG. 2, according to the current mode of each antenna panel, the configuration information ID of the current configuration information of panel #1 is TRAC ID #1; the configuration information ID of the current configuration information of panel #2 is TRAC ID #3; the configuration information ID of the current configuration information of panel #4 is TRAC ID #8; panel #3 has no corresponding configuration information since its current working state is idle. As shown in FIG. 2, a downlink reference signal indication of panel #1 for the at least one downlink reference signal is CRI #1, it is assumed that a channel quality measurement result of panel #1 on a downlink reference signal corresponding to the downlink reference signal indication CRI #1 is L1-RSRP #1; a downlink reference signal indication of panel #2 for the at least one downlink reference signal is CRI #2, it is assumed that a channel quality measurement result of panel #2 on a downlink reference signal corresponding to the downlink reference signal indication CRI #2 is L1-RSRP #2; a downlink reference signal indication of panel #4 for the at least one downlink reference signal is CRI #4, it is assumed that a channel quality measurement result of panel #4 on a downlink reference signal corresponding to the downlink reference signal indication CRI #4 is L1-RSRP #4. panel #3 has no corresponding downlink reference signal indication since its current working state of panel #3 is an idle state, and thus the electronic apparatus 100 does not report information about panel #3 in a beam reporting stage.

As shown in Table 1 below, the electronic apparatus 100 reports, in beam reporting, the above information of panel #1, pane #2 and panel #4 that are not in an idle state to the network side equipment. As examples, a differential L1-RSRP #2 in Table 1 may represent a difference between L1-RSRP #2 and L1-RSRP #1, and a differential L1-RSRP #4 may represent a difference between L1-RSRP #4 and L1-RSRP #1.

TABLE 1

| CSI Report Numbers | CSI Fields |
|---|---|
| CSI Reports | CRI#1 |
| | CRI#2 |
| | CRI#4 |
| | L1-RSRP#1 |
| | Differential L1-RSRP#2 |
| | Differential L1-RSRP#4 |
| | TRAC ID#1 |
| | TRAC ID#3 |
| | TRAC ID#8 |

As an example, the processing unit 101 may be configured to, for each antenna panel that is not in an idle state: obtain a channel quality measurement result of the antenna panel on the received at least one downlink reference signal, and report the downlink reference signal indication for a downlink reference signal with a maximum channel quality measurement result.

It is assumed that the electronic apparatus 100 receives a downlink reference signal sent by the network side equipment through M beams, where M is a positive integer greater than or equal to 1. Taking the antenna panel panel #1 as an example, it is assumed that panel #1 has P beams, where P is a positive integer greater than or equal to 1. panel #1 may obtain MxP channel quality measurement results, and report a downlink reference signal indication CRI #1 for a downlink reference signal CSI-RS #1 with a maximum channel quality measurement result among the MxP channel quality measurement results. Similarly to the description of panel #1, panel #2 reports a downlink reference signal indication CRI #2 for a downlink reference signal CSI-RS #2 with a maximum channel quality measurement result, and panel #4 reports a downlink reference signal indication CRI #4 for a downlink reference signal CSI-RS #4 with a maximum channel quality measurement result.

As an example, the processing unit 101 may be configured to determine an antenna panel associated with a downlink reference signal indication selected by the network side equipment, to perform uplink transmission with the antenna panel.

For example, assuming that the network side equipment has selected CRI #1 from the downlink reference signal indications CRI #1, CRI #2 and CRI #4, then the electronic apparatus 100 may determine, based on associations between the antenna panels and the downlink reference signals (for example, as shown in FIG. 2, the configuration information IDs of the antenna panels are dedicated to specific antenna panels, so there is a one-to-one correspondence between the configuration information IDs and the downlink reference signals), that an antenna panel associated with CRI #1 is panel #1 with TRAC ID #1. Accordingly, the electronic apparatus 100 may perform uplink transmission with the antenna panel panel #1. Specifically, the electronic apparatus 100 may perform uplink transmission with a beam corresponding to CRI #1 among the P beams of the antenna panel panel #1

Similarly to FIG. 2, as shown in FIG. 3, a downlink reference signal indication of panel #1 for at least one downlink reference signal received from the network side equipment is CRI #1; a downlink reference signal indication of panel #2 for the at least one downlink reference signal is CRI #2; a downlink reference signal indication of panel #4 for the at least one downlink reference signal is CRI #4. panel #3 has no corresponding downlink reference signal indication since its current working state is an idle state, and thus the electronic apparatus 100 does not report information about panel #3 in the beam reporting stage. An example of selecting an antenna panel for uplink transmission from a plurality of antenna panels based on the configuration information in FIG. 3 is essentially the same as the above-mentioned example of selecting an antenna panel for uplink transmission from a plurality of antenna panels based on the configuration information in FIG. 2, which will not be repeatedly described here.

It should be noted that, in a case where both the configuration information IDs of the current configuration information of panel #1 and panel #2 in FIG. 3 are TRAC ID #1′, although there is no one-to-one correspondence between the configuration information IDs of panel #1 and panel #2 and the downlink reference signals, before the electronic apparatus 100 performs reporting to the network side equipment in the beam reporting stage, it has been known to the electronic apparatus 100 that panel #1 corresponds to CRI #1 and that panel #2 corresponds to CRI #2. Therefore, if the network side equipment has selected CRI #1 from the downlink reference signal indications CRI #1, CRI #2 and CRI #4, the electronic apparatus 100 can still determine that the antenna panel associated with CRI #1 is panel #1. Accordingly, the electronic apparatus 100 can perform uplink transmission with the antenna panel panel #1.

FIG. 4 is a signaling interaction diagram showing selection of an antenna panel for uplink transmission from a plurality of antenna panels based on configuration information which is performed between the electronic apparatus 100 according to the embodiment of the present disclosure and network side equipment. Here, description is made by taking the electronic apparatus 100 working as user equipment an example.

As shown in FIG. 4, in S41, the electronic apparatus 100, upon initial access to the network side equipment, reports mode information of each antenna panel to the network side equipment, for the network side equipment to set configuration information for each antenna panel based on the mode information. In S42, the electronic apparatus 100 receives the configuration information set by the network side equipment for each antenna panel of the plurality of antenna panels through RRC signaling. In S43, the network side equipment performs downlink beam scanning. In S44, the electronic apparatus 100 performs beam reporting to the network side equipment based on the configuration information. In S45, the network side equipment performs uplink scheduling, that is, selects an antenna panel for uplink transmission from a plurality of antenna panels based on the configuration information. In S46, the electronic apparatus 100 performs uplink transmission using the antenna panel selected by the network side equipment.

As an example, the processing unit 101 may be configured to report, for at least one antenna panel of the plurality of antenna panels, a configuration information ID of configuration information, power margin, maximum transmit power, and maximum allowable exposure of the at least one antenna panel.

FIG. 5 is a diagram showing reporting power margin for a plurality of antenna panels by the electronic apparatus 100 according to the embodiment of the present disclosure. FIG. 5 shows reporting power margin for N antenna panels, where N is a positive integer greater than or equal to 1.

In FIG. 5, TRAC ID represents a configuration information ID of configuration information of an antenna panel, PH represents power margin, PCMAX represents maximum transmit power, MPE represents maximum allowable exposure, and R represents “reservation”. P is two bits, P=1 represents that MPE has been reported, and P=0 represents that MPE is not used. For example, the maximum allowable exposure represents a maximum amount of electromagnetic radiation that will not produce adverse consequences when a human body suffers from that electromagnetic radiation.

As can be known from the above description, the electronic apparatus 100 according to the embodiment of the present disclosure can report power margin for a specific antenna panel based on configuration information.

As an example, the processing unit 101 may be configured to perform the reporting about the power margin for the at least one antenna panel through a media access control element (MAC CE).

In a high-speed transmission single frequency network (HST-SFN) in a high-speed rail scenario, a constantly changing Doppler frequency offset is generated due to high-speed movement of user equipment, thereby causing a frequency of an uplink signal received by a base station to change. In order to enable the base station to receive uplink signals of unified carrier frequencies, Doppler frequency shift pre-compensation is required to be performed. In the HST-SFN scenario, for the electronic apparatus 100 with a plurality of antenna panels, a Doppler frequency offset of an uplink signal of each antenna panel that reaches a corresponding base station is not the same.

As an example, the processing unit 101 may be configured to: report, to the network side equipment, that at least one antenna panel of the plurality of antenna panels supports uplink Doppler frequency shift pre-compensation independent of other antenna panels; receive configuration information of supporting uplink Doppler frequency shift pre-compensation of the at least one antenna panel independent of the other antenna panels, which is set by the network side equipment; and for the at least one antenna panel, estimate a downlink Doppler frequency shift by measuring a downlink time reference signal (TRS), and perform uplink Doppler frequency shift pre-compensation based on the estimated downlink Doppler frequency shift.

As can be known from the above description, the electronic apparatus 100 according to the embodiment of the present disclosure can perform uplink Doppler frequency shift pre-compensation specific to an antenna panel based on configuration information.

As an example, the processing unit 101 may be configured to: report, to the network side equipment, that at least one antenna panel of the plurality of antenna panels supports uplink timing advance independent of other antenna panels; receive configuration information of supporting uplink timing advance of the at least one antenna panel independent of the other antenna panels, which is set by the network side equipment; and receive, from the network side equipment, a configuration information ID of the configuration information, an uplink timing advance command, and an ID of a timing advance group of the at least one antenna panel.

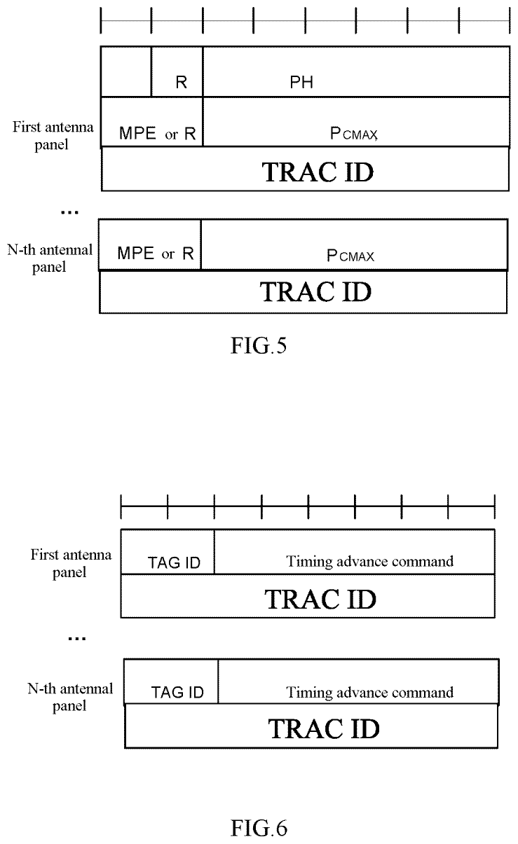

FIG. 6 shows a diagram including uplink timing advance commands of a plurality of antenna panels which are received by the electronic apparatus according to the embodiment of the present disclosure from network side equipment. In FIG. 6, uplink timing advance commands for N antenna panels are received through an MAC CE.

In FIG. 6, TAG ID represents an ID of a timing advance group, and TRAC ID represents a configuration information ID of configuration information of an antenna panel.

As can be known from the above description, the electronic apparatus 100 according to the embodiment of the present disclosure can receive an uplink timing advance command for a specific antenna panel based on configuration information.

As an example, the processing unit 101 may be configured to: report, to the network side equipment, that at least one antenna panel of the plurality of antenna panels supports uplink power control independent of other antenna panels; receive configuration information of supporting uplink power control of the at least one antenna panel independent of the other antenna panels, which is set by the network side equipment; and based on a configuration information ID of the configuration information of the at least one antenna panel and a power control command corresponding to the at least one antenna panel received from the network side equipment, for the network side equipment to perform uplink power control.

For example, when the network side equipment sends an uplink power control command, it simultaneously sends a configuration information ID of configuration information to indicate an antenna panel corresponding to the uplink power control command.

As an example, the power control command includes transmission power control commands of a physical uplink control channel (PUCCH) and a physical uplink shared channel (PUSCH); and the processing unit 101 may be configured to receive the configuration information ID and the power control commands from the network side equipment via a downlink control information (DCI) format.

For example, DCI format2_2 carries the transmission power control commands of the PUCCH and the PUSCH, and thus TRAC ID is added in DCI format2_2, which may allow the network side equipment to perform, specifically to an antenna panel, transmission power control of the PUCCH and the PUSCH.

As an example, the power control command includes an SRS power control command; and the processing unit 101 may be configured to receive the configuration information ID and the power control commands from the network side equipment via a DCI format.

For example, DCI format2_3 carries an SRS power control command, and thus TRAC ID is added in DCI format2_3, which may allow the network side equipment to perform, specifically to an antenna panel, SRS power control.

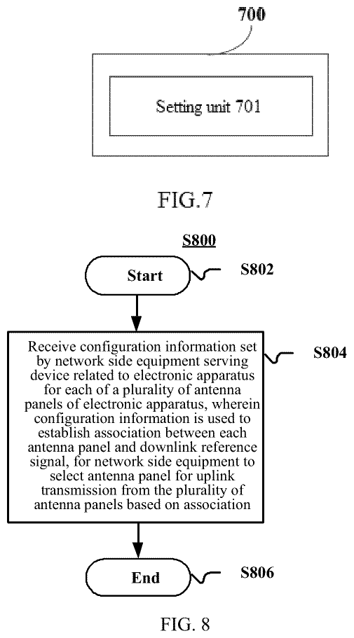

The present disclosure further provides an electronic apparatus for wireless communications according to another embodiment. FIG. 7 shows a block diagram of functional modules of an electronic apparatus 700 for wireless communications according to another embodiment of the present disclosure. As shown in FIG. 7, an electronic apparatus 700 comprises: a setting unit 701 which may set, for user equipment within coverage of a device related to the electronic apparatus 700, configuration information for each of a plurality of antenna panels of the user equipment, wherein the configuration information is used to establish an association between each antenna panel and a downlink reference signal, for the electronic apparatus 700 to select an antenna panel for uplink transmission from the plurality of antenna panels based on the association.

Wherein, the setting unit 701 may be implemented by one or more processing circuitries which may be implemented as, for example, a chip.

The electronic apparatus 700 may serve as network side equipment in a wireless communication system, and specifically may be arranged on a base station side or may be communicatively connected to a base station, for example. In a case where the electronic apparatus 700 is arranged on a base station side or is communicatively connected to a base station, the device related to the electronic equipment 700 may be the base station. Here, it should also be noted that, the electronic apparatus 700 may be implemented either at chip level or at device level. For example, the electronic apparatus 700 may work as a base station itself, and may also include external devices such as a memory, a transceiver (not shown) and the like. The memory may be used to store programs and related data information that the base station needs to execute in order to implement various functions. The transceiver may include one or more communication interfaces to support communication with different devices (e.g., user equipment, other base stations, etc.), and no implementation form of the transceiver is specifically limited here.

As an example, the electronic apparatus 700 may be the network side equipment involved in the foregoing embodiment of the electronic apparatus 100.

In the embodiment according to the present disclosure, antenna panels can be identified from configuration information set by the electronic apparatus 700 for each antenna panel of the user equipment, while not exposing an implementation manner such as array arrangement and the like of the antenna panels, which is applicable not only to heterogeneous antennas but also to homogeneous antennas.

As an example, the electronic apparatus 700 may be configured to set the configuration information through RRC signaling. In addition to the RRC signaling, those skilled in the art can think of other ways of setting configuration information, which will not be repeatedly described here.

As an example, the configuration information includes configuration information ID, the number of SRS ports of the antenna panel capable of emitting a sounding reference signal SRS, a type of coherent transmission between the SRS ports, and a working state of the antenna panel.

As an example, the type of coherent transmission between the SRS ports includes one of non-coherent transmission, partially-coherent transmission, and fully-coherent transmission.

As an example, the working state of the antenna panel includes one of a state of the antenna panel supporting only downlink reception, a state of the antenna panel supporting downlink reception and uplink transmission, and the antenna panel being in an idle state.

As an example, the configuration information further includes latency information of the antenna panel.

As an example, the latency information includes activation latency and selection latency of the antenna panel. The activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and the selection latency includes latency generated between performing uplink scheduling by the network side equipment and performing uplink transmission by the electronic apparatus.

As an example, the configuration information further includes a flag indicating whether the antenna panel supports at least one of uplink timing advance, uplink Doppler shift pre-compensation, and uplink power control independent of other antenna panels.

As an example, the configuration information is set by the electronic apparatus for each antenna panel respectively, so that different antenna panels do not have the same configuration information. As an example, each antenna panel corresponds to at least one piece of configuration information, and each of the at least one piece of configuration information corresponds to one mode of the antenna panel respectively. For an example of the configuration information set for each antenna panel, please refer to the description of FIG. 2, which will not be repeatedly described here. Each piece of configuration information is dedicated to a certain antenna panel, and different antenna panels do not have the same configuration information.

As an example, the configuration information is selected from a configuration information pool set by the electronic apparatus for the plurality of antenna panels, so that different antenna panels with the same mode share the same configuration information. As an example, each antenna panel corresponds to at least one piece of configuration information, and each of the at least one piece of configuration information corresponds to one mode of the antenna panel respectively. For an example of the configuration information being selected from the configuration information pool set for plurality of antenna panels, please refer to the description of FIG. 3, which will not be repeatedly described here. The configuration information pool may save resources for setting configuration information.

As an example, the setting unit 701 may be configured to receive, upon initial access of the user equipment to the device related to the electronic apparatus 700, mode information related to configuration information of each antenna panel from the user equipment, for the electronic apparatus 700 to set the configuration information based on the mode information.

As an example, the mode information includes the number of SRS ports of the antenna panel, a type of coherent transmission between the SRS ports, and a working state of the antenna panel. As an example, the type of coherent transmission between the SRS ports includes one of non-coherent transmission, partially-coherent transmission and fully-coherent transmission. As an example, the working state of the antenna panel includes one of a state of the antenna panel supporting only downlink reception, a state of the antenna panel supporting downlink reception and uplink transmission, and the antenna panel being in an idle state.

As an example, the mode information further includes latency information of the antenna panel.

As an example, the latency information includes activation latency and selection latency of the antenna panel, the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and the selection latency includes latency generated between performing uplink scheduling by the network side equipment and performing uplink transmission by the electronic apparatus.

As an example, the mode information further includes a flag indicating whether the antenna panel supports at least one of uplink timing advance, uplink Doppler shift pre-compensation, and uplink power control independent of other antenna panels.

As an example, the downlink reference signal includes a channel state information reference signal CSI-RS or a synchronization signal block SSB.

As an example, the setting unit 701 may be configured to send at least one downlink reference signal to user equipment, and the setting unit 701 may be configured to receive, in beam reporting, a configuration information ID of configuration information of each antenna panel that is not in an idle state, a downlink reference signal indication of the antenna panel for the at least one downlink reference signal, and a channel quality measurement result of the antenna panel on a downlink reference signal corresponding to the downlink reference signal indication, from the user equipment.

As an example, the channel quality measurement result includes L1-RSRP or L1-SINR.

For contents received by the electronic apparatus 700 from the user equipment in the beam reporting, reference made be made to Table 1 as described above, which will not be repeatedly described here.

As an example, a channel quality measurement result on the downlink reference signal corresponding to the downlink reference signal indication is a maximum value among channel quality measurement results of the antenna panel on the received at least one downlink reference signal. As an example, the setting unit 701 may be configured to perform selection for received downlink reference signal indications, and to use an antenna panel associated with the selected downlink reference signal indication as the antenna panel for uplink transmission. For related contents, reference may be made to the description of the corresponding parts made in conjunction with FIG. 3 and FIG. 4 in the embodiment of the electronic apparatus 100, which will not be repeatedly described here.

As an example, the setting unit 701 may be configured to receive, from at least one antenna panel of the plurality of antenna panels, a configuration information ID of configuration information, power margin, maximum transmit power, and maximum allowable exposure of the at least one antenna panel. For related contents, reference may be made to the description made in conjunction with FIG. 5, which will not be repeatedly described here.

As can be known from the above description, the electronic apparatus 700 according to the embodiment of the present disclosure can receive power margin reported by the antenna panel based on configuration information.

As an example, the setting unit 701 may be configured to perform the receiving for the at least one antenna panel through an MAC CE.

As an example, the setting unit 701 may be configured to: receive mode information from the user equipment, the mode information including that at least one antenna panel of the plurality of antenna panels supports uplink Doppler frequency shift pre-compensation independent of other antenna panels; and set configuration information of supporting uplink Doppler frequency shift pre-compensation of the at least one antenna panel independent of the other antenna panels, for the at least one antenna panel to perform uplink Doppler frequency shift pre-compensation.

As can be known from the above description, the electronic apparatus 700 according to the embodiment of the present disclosure can set uplink Doppler frequency shift pre-compensation specific to an antenna panel based on configuration information.

As an example, the setting unit 701 may be configured to: receive mode information from the user equipment, the mode information including that at least one antenna panel of the plurality of antenna panels supports uplink timing advance independent of other antenna panels; set configuration information of supporting uplink timing advance of the at least one antenna panel independent of the other antenna panels; and send a configuration information ID of the configuration information, an uplink timing advance command, and an ID of the timing advance group of the at least one antenna panel to the user equipment. For related contents, reference may be made to the description made in conjunction with FIG. 6, which will not be repeatedly described here.

As can be known from the above description, the electronic apparatus 700 according to the embodiment of the present disclosure can set an uplink timing advance command for a specific antenna panel based on configuration information.

As an example, the setting unit 701 may be configured to: receive mode information from the user equipment, the mode information including that at least one antenna panel of the plurality of antenna panels supports uplink power control independent of other antenna panels; set configuration information of supporting uplink power control of the at least one antenna panel independent of the other antenna panels; and send a configuration information ID of the configuration information of the at least one antenna panel, and a power control command corresponding to the at least one antenna panel, to the user equipment to perform uplink power control.

For example, when the electronic apparatus 700 sends an uplink power control command, it simultaneously sends a configuration information ID of configuration information to indicate an antenna panel corresponding to the uplink power control command.

As an example, the power control command includes transmission power control commands of a PUCCH and a PUSCH; and the setting unit 701 may be configured to send the configuration information ID and the power control commands via a DCI format.

For example, DCI format2_2 carries the transmission power control commands of the PUCCH and the PUSCH, and thus TRAC ID is added in DCI format2_2, which may allow the electronic apparatus 700 to perform, for specific antenna panel, transmission power control of the PUCCH and the PUSCH.

As an example, the power control command includes an SRS power control command; and the setting unit 701 may be configured to send the configuration information ID and the power control commands via a DCI format.

For example, DCI format2_3 carries an SRS power control command, and thus TRAC ID is added in DCI format2_3, which may allow the electronic apparatus 700 to perform, for an antenna panel, SRS power control.

As can be known from the above description, the electronic apparatus 700 according to the embodiment of the present disclosure can perform uplink power control for a specific antenna panel based on configuration information.

In the process of describing the electronic apparatuses for wireless communications in the above implementations, some processing or methods obviously have also been disclosed. Hereinafter, an outline of these methods will be given without repeating some of the details that have been discussed above; however, it should be noted that, although these methods are disclosed in the process of describing electronic apparatuses for wireless communications, these methods do not necessarily employ those components as described or are not necessarily executed by those components. For example, the implementations of the electronic apparatuses for wireless communications may be partially or completely realized using hardware and/or firmware, while the methods for wireless communications discussed below may be completely implemented by a computer-executable program, although these methods may also employ hardware and/or firmware of the electronic apparatuses for wireless communications.

FIG. 8 shows a flowchart of a method S800 for wireless communications according to an embodiment of the present disclosure. The method S800 starts in step S802. In step S804, configuration information set by network side equipment serving a device related to the electronic apparatus for each of a plurality of antenna panels of the electronic apparatus is received, wherein the configuration information is used to establish an association between each antenna panel and a downlink reference signal, for the network side equipment to select an antenna panel for uplink transmission from the plurality of antenna panels based on the association. The method S800 ends in step S806.

The method may be executed by, for example, the electronic apparatus 100 as described above. For details thereof, reference may be made to the description at the above corresponding position, which will not be repeated here.

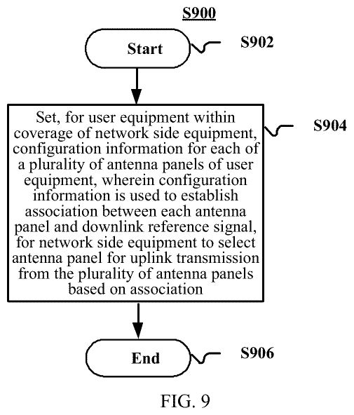

FIG. 9 shows a flowchart showing a method S900 for wireless communications according to another embodiment of the present disclosure. The method S900 starts in step S902. In step S904, for user equipment within coverage of network side equipment, configuration information is set for each of a plurality of antenna panels of the user equipment, wherein the configuration information is used to establish an association between each antenna panel and a downlink reference signal, for the network side equipment to select an antenna panel for uplink transmission from the plurality of antenna panels based on the association. The method S900 ends in step S906.

The method may be executed by, for example, the electronic apparatus 700 as described above. For details thereof, reference may be made to the description at the above corresponding position, which will not be repeated here.

The technology of the present disclosure can be applied to various products.

The electronic apparatus 100 may be implemented as various user equipment. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that executes Machine-to-Machine (M2M) communications. In addition, the user equipment may be a wireless communication module (such as an integrated circuit module including a single chip) installed on each of the above-mentioned terminals.

The electronic apparatus 700 may be implemented as various user side equipment such as base stations. The base station may be implemented as any type of evolved Node B (eNB) or gNB (5G base station). An eNB includes, for example, macro eNBs and small eNBs. A small eNB may be an eNB that covers a cell smaller than a macro cell, such as a pico eNB, a micro eNB, and a home (femto) eNB. A similar situation can also apply to gNBs. Alternatively, the base station may be implemented as any other type of base station, such as a NodeB and a base transceiver station (BTS). The base station may include: a main body (also referred to as base station equipment) configured to control wireless communications; and one or more remote radio heads (RRHs) arranged at a different place from the main body. In addition, various types of electronic apparatuses can all operate as base stations by temporarily or semi-persistently performing base station functions.

### Application Examples about Base Station

### First Application Example

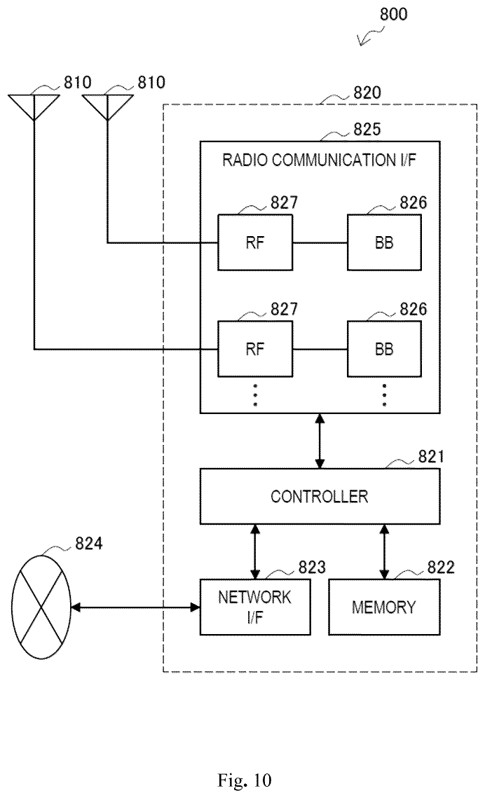

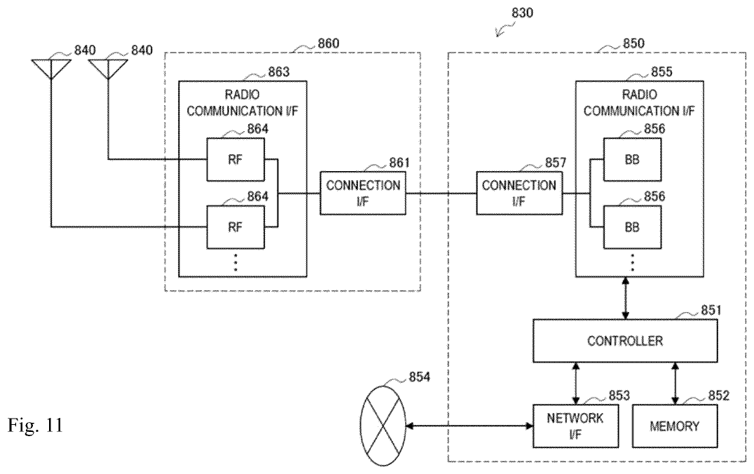

FIG. 10 is a block diagram showing a first example of a schematic configuration of an eNB or gNB to which the technology of the present disclosure can be applied. Note that, the following description takes an eNB as an example, but it may also be applied to a gNB. An eNB 800 includes one or more antennas 810 and base station equipment 820. The base station equipment 820 and each antenna 810 may be connected to each other via an RF cable.

Each of the antennas 810 includes a single or multiple antenna elements (such as multiple antenna elements included in a Multi-Input Multi-Output (MIMO) antenna), and is used for the base station equipment 820 to transmit and receive wireless signals. As shown in FIG. 10, the eNB 800 may include multiple antennas 810. For example, the multiple antennas 810 may be compatible with multiple frequency bands used by the eNB 800. Although FIG. 10 shows an example in which the eNB 800 includes multiple antennas 810, the eNB 800 may also include a single antenna 810.

The base station equipment 820 includes a controller 821, a memory 822, a network interface (I/F) 823, and a radio communication interface 825.

The controller 821 may be, for example, a CPU or a DSP, and manipulate various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have a logical function for performing control such as radio resource control, radio bearer control, mobility management, admission control, and scheduling. The control may be executed in conjunction with nearby eNBs or core network nodes. The memory 822 includes an RAM and an ROM, and stores programs executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an S1 interface and an X2 interface). The network interface 823 may also be a wired communication interface, or a wireless communication interface for a wireless backhaul line. If the network interface 823 is a wireless communication interface, the network interface 823 may use a higher frequency band for wireless communications than the frequency band used by the radio communication interface 825.

The radio communication interface 825 supports any cellular communication scheme (such as Long Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 10, the radio communication interface 825 may include multiple BB processors 826. For example, the multiple BB processors 826 may be compatible with multiple frequency bands used by the eNB 800. As shown in FIG. 10, the radio communication interface 825 may include multiple RF circuits 827. For example, the multiple RF circuits 827 may be compatible with multiple antenna elements. Although FIG. 10 shows an example in which the radio communication interface 825 includes multiple BB processors 826 and multiple RF circuits 827, the radio communication interface 825 may also include a single BB processor 826 or a single RF circuit 827.

In the eNB 800 as shown in FIG. 10, when the electronic apparatus 700 described with reference to FIG. 7 is implemented as a base station, its transceiver may be implemented by a radio communication interface 825. At least a part of the function may also be implemented by the controller 821. For example, the controller 821 may set configuration information for each antenna panel of a plurality of antenna panels by executing the function of the setting unit 701 described above with reference to FIG. 7.

### Second Application Example

FIG. 11 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. The RRH 860 and each antenna 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna) and is used for the RRH 860 to transmit and receive a wireless signal. As shown in FIG. 11, the eNB 830 may include multiple antennas 840. For example, the multiple antennas 840 may be compatible with multiple frequency bands used by the eNB 830. Although FIG. 11 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 10.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 10 except that the BB processor 856 is connected to the RF circuit 864 of the RRH 860 via the connection interface 857. As shown in FIG. 11, the radio communication interface 855 may include multiple BB processors 856. For example, the multiple BB processors 856 may be compatible with multiple frequency bands used by the eNB 830. Although FIG. 11 shows an example in which the radio communication interface 855 includes multiple BB processors 856, the radio communication interface 855 may also include a single BB processor 856.

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 11, the radio communication interface 863 may include multiple RF circuits 864. For example, the multiple RF circuits 864 may support multiple antenna elements. Although FIG. 11 shows an example in which the radio communication interface 863 includes multiple RF circuits 864, the radio communication interface 863 may also include a single RF circuit 864.

In the eNB 830 as shown in FIG. 11, when the electronic apparatus 700 described with reference to FIG. 7 is implemented as a base station, its transceiver may be implemented by the radio communication interface 855. At least a part of the function may also be implemented by the controller 851. For example, the controller 851 may set configuration information for each antenna panel of a plurality of antenna panels by executing the function of the setting unit 701 described above with reference to FIG. 7.

### Application Example about User Equipment

### First Application Example

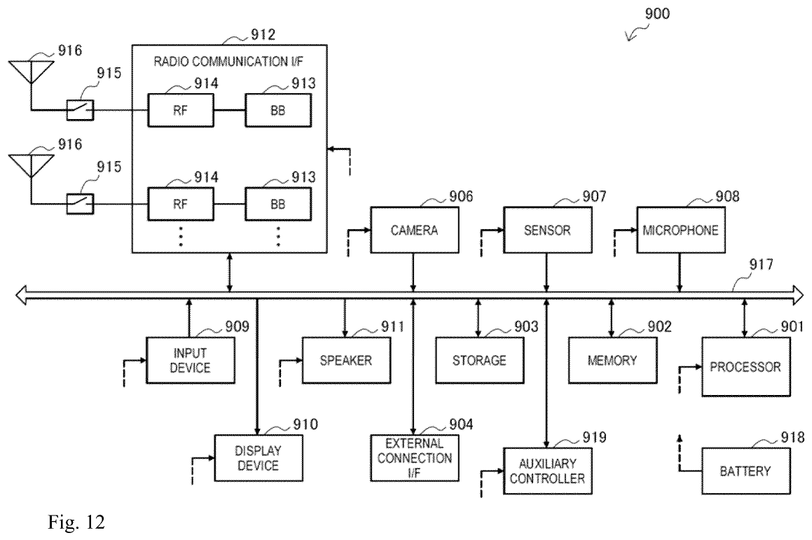

FIG. 12 is a block diagram showing an example of a schematic configuration of a smart phone to which the technology of the present disclosure can be applied. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetic sensor, and an acceleration sensor. The microphone 908 converts sound input to the smart phone 900 into an audio signal. The input device 909 includes, for example, a touch sensor, a keypad, a keyboard, a button, or a switch configured to detect a touch on a screen of the display device 910, and receives an operation or information input from the user. The display device 910 includes a screen (such as a liquid crystal display (LCD) and an organic light emitting diode (OLED) display), and displays an output image of the smart phone 900. The speaker 911 converts the audio signal output from the smart phone 900 into sound.

The radio communication interface 912 supports any cellular communication scheme (such as LTE and LTE-Advanced), and executes wireless communications. The radio communication interface 912 may generally include, for example, a BB processor 913 and an RF circuit 914. The BB processor 913 may execute, for example, encoding/decoding, modulation/demodulation, and multiplexing/demultiplexing, and execute various types of signal processing for wireless communications. Meanwhile, the RF circuit 914 may include, for example, a mixer, a filter, and an amplifier, and transmit and receive wireless signals via the antenna 916. Note that, although the figure shows a circumstance where one RF link is connected with one antenna, this is only schematic, and a circumstance where one RF link is connected with multiple antennas through multiple phase shifters is also included. The radio communication interface 912 may be a chip module on which the BB processor 913 and the RF circuit 914 are integrated. As shown in FIG. 12, the radio communication interface 912 may include multiple BB processors 913 and multiple RF circuits 914. Although FIG. 12 shows an example in which the radio communication interface 912 includes multiple BB processors 913 and multiple RF circuits 914, the radio communication interface 912 may also include a single BB processor 913 or a single RF circuit 914.

Furthermore, in addition to the cellular communication scheme, the radio communication interface 912 may support other types of wireless communication schemes, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits included in the radio communication interface 912 (e.g., circuits for different wireless communication schemes).

Each of the antennas 916 includes a single or multiple antenna elements (such as multiple antenna elements included in a MIMO antenna), and is used for the radio communication interface 912 to transmit and receive wireless signals. As shown in FIG. 12, the smart phone 900 may include multiple antennas 916. Although FIG. 12 shows an example in which the smart phone 900 includes multiple antennas 916, the smart phone 900 may also include a single antenna 916.

Furthermore, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smart phone 900 as shown in FIG. 12 via a feeder line, which is partially shown as a dashed line in the figure. The auxiliary controller 919 manipulates the least necessary function of the smart phone 900 in a sleep mode, for example.

In the smart phone 900 as shown in FIG. 12, when the electronic apparatus 100 described with reference to FIG. 1 is implemented, for example, as a smart phone at a user equipment side, a transceiver of the electronic apparatus 100 may be implemented by the radio communication interface 912. At least a part of the function may also be implemented by the processor 901 or the auxiliary controller 919. For example, the processor 901 or the auxiliary controller 919 may receive configuration information set by network side equipment for each antenna panel of a plurality of antenna panels by executing the function of the processing unit 101 described above with reference to FIG. 1.

### Second Application Example

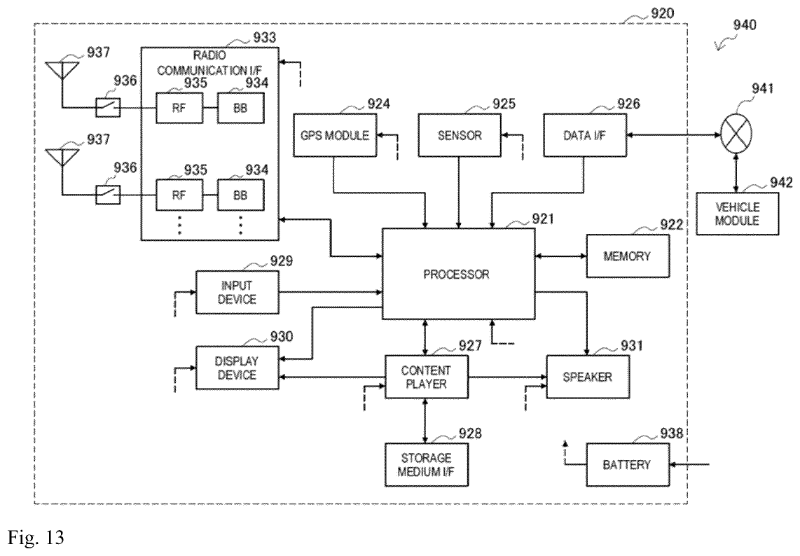

FIG. 13 is a block diagram showing an example of a schematic configuration of automobile navigation equipment to which the technology of the present disclosure can be applied. The automobile navigation equipment 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function of the automobile navigation equipment 920 and additional functions. The memory 922 includes an RAM and an ROM, and stores data and programs executed by the processor 921.

The GPS module 924 uses a GPS signal received from a GPS satellite to measure a position of the automobile navigation equipment 920 (such as latitude, longitude, and altitude). The sensor 925 may include a group of sensors, such as a gyro sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD), which is inserted into the storage medium interface 928. The input device 929 includes, for example, a touch sensor, a button, or a switch configured to detect a touch on a screen of the display device 930, and receives an operation or information input from the user. The display device 930 includes a screen such as an LCD or OLED display, and displays an image of a navigation function or reproduced content. The speaker 931 outputs the sound of the navigation function or the reproduced content.

The radio communication interface 933 supports any cellular communication scheme, such as LTE and LTE-Advanced, and executes wireless communication. The radio communication interface 933 may generally include, for example, a BB processor 934 and an RF circuit 935. The BB processor 934 may execute, for example, encoding/decoding, modulation/demodulation, and multiplexing/demultiplexing, and execute various types of signal processing for wireless communications. Meanwhile, the RF circuit 935 may include, for example, a mixer, a filter, and an amplifier, and transmit and receive wireless signals via the antenna 937. The radio communication interface 933 may also be a chip module on which the BB processor 934 and the RF circuit 935 are integrated. As shown in FIG. 13, the radio communication interface 933 may include multiple BB processors 934 and multiple RF circuits 935. Although FIG. 13 shows an example in which the radio communication interface 933 includes multiple BB processors 934 and multiple circuits 935, the radio communication interface 933 may also include a single BB processor 934 or a single RF circuit 935.

Furthermore, in addition to the cellular communication scheme, the radio communication interface 933 may support types of wireless communication schemes, such as a short-range wireless communication scheme, a near field communication scheme, and a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits included in the radio communication interface 933 (e.g., circuits for different wireless communication schemes).

Each of the antennas 937 includes a single or multiple antenna elements (such as multiple antenna elements included in a MIMO antenna), and is used for the radio communication interface 933 to transmit and receive wireless signals. As shown in FIG. 13, the automobile navigation equipment 920 may include multiple antennas 937. Although FIG. 13 shows an example in which the automobile navigation equipment 920 includes multiple antennas 937, the automobile navigation equipment 920 may also include a single antenna 937.

Furthermore, the automobile navigation equipment 920 may include an antenna 937 for each wireless communication scheme. In this case, the antenna switch 936 may be omitted from the configuration of the automobile navigation equipment 920.

The battery 938 supplies power to each block of the automobile navigation equipment 920 as shown in FIG. 13 via a feeder line, which is partially shown as a dashed line in the figure. The battery 938 accumulates electric power supplied from the vehicle.

In the automobile navigation equipment 920 as shown in FIG. 13, when the electronic apparatus 100 described with reference to FIG. 1 is implemented, for example, as automobile navigation equipment at a user equipment side, a transceiver of the electronic apparatus 100 may be implemented by the radio communication interface 933. At least a part of the function may also be implemented by the processor 921. For example, the processor 921 may receive configuration information set by network side equipment for each antenna panel of a plurality of antenna panels by executing the function of the processing unit 101 described above with reference to FIG. 1.

The technology of the present disclosure may also be implemented as an in-vehicle system (or vehicle) 940 including one or more blocks in the automobile navigation equipment 920, the in-vehicle network 941, and the vehicle module 942. The vehicle module 942 generates vehicle data (such as vehicle speed, engine speed, and failure information), and outputs the generated data to the in-vehicle network 941.

The basic principle of the present invention has been described above in conjunction with specific embodiments. However, it should be pointed out that, for those skilled in the art, it could be understood that all or any step or component of the methods and devices of the present invention may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present invention.

Moreover, the present invention also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

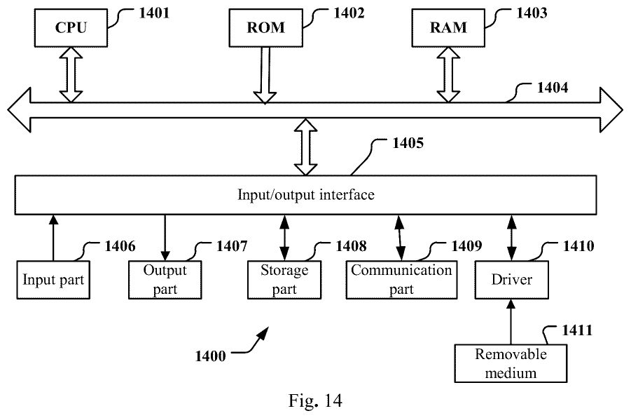

In a case where the present invention is implemented by software or firmware, a program constituting the software is installed from a storage medium or a network to a computer with a dedicated hardware structure (e.g., a general-purpose computer 1400 as shown in FIG. 14), and the computer, when installed with various programs, can execute various functions and the like.

In FIG. 14, a central processing unit (CPU) 1401 executes various processing in accordance with a program stored in a read only memory (ROM) 1402 or a program loaded from a storage part 1408 to a random access memory (RAM) 1403. In the RAM 1403, data required when the CPU 1401 executes various processing and the like is also stored as needed. The CPU 1401, the ROM 1402, and the RAM 1403 are connected to each other via a bus 1404. The input/output interface 1405 is also connected to the bus 1404.

The following components are connected to the input/output interface 1405: an input part 1406 (including a keyboard, a mouse, etc.), an output part 1407 (including a display, such as a cathode ray tube (CRT), a liquid crystal display (LCD), etc., and a speaker, etc.), a storage part 1408 (including a hard disk, etc.), and a communication part 1409 (including a network interface card such as an LAN card, a modem, etc.). The communication part 1409 executes communication processing via a network such as the Internet. The driver 1410 may also be connected to the input/output interface 1405, as needed. A removable medium 1411 such as a magnetic disk, an optical disk, a magneto-optical disk, a semiconductor memory and the like is installed on the driver 1410 as needed, so that a computer program read out therefrom is installed into the storage part 1408 as needed.

In a case where the above-mentioned series of processing is implemented by software, a program constituting the software is installed from a network such as the Internet or a storage medium such as the removable medium 1411.

Those skilled in the art should understand that, this storage medium is not limited to the removable medium 1411 as shown in FIG. 14 which has a program stored therein and which is distributed respectively from an apparatus to provide the program to users. Examples of the removable media 1411 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 1402, a hard disk included in the storage part 1408, etc., which have programs stored therein and which are distributed concurrently with the apparatus including them to users.

It should also be pointed out that in the devices, methods and systems of the present invention, each component or each step may be decomposed and/or recombined. These decompositions and/or recombinations should be regarded as equivalent solutions of the present invention. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or but also includes elements inherent to such a process, method, article, or apparatus. Furthermore, in the absence of more restrictions, an element defined by sentence “including one . . . ” does not exclude the existence of other identical elements in a process, method, article, or apparatus that includes the element.

Although the embodiments of the present invention have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof.

This technology can also be implemented as follows.
Solution 1. An electronic apparatus for wireless communications, comprising:
processing circuitry configured to receive configuration information set by network side equipment serving a device related to the electronic apparatus for each of a plurality of antenna panels of the electronic apparatus,
wherein the configuration information is used to establish an association between each antenna panel and a downlink reference signal, for the network side equipment to select an antenna panel for uplink transmission from the plurality of antenna panels based on the association.
Solution 2. The electronic apparatus according to Solution 1, wherein the processing circuitry is configured to receive the configuration information from the network side equipment through radio resource control RRC signaling.
Solution 3. The electronic apparatus according to Solution 1 or 2, wherein the configuration information includes configuration information ID, the number of SRS ports of the antenna panel capable of emitting a sounding reference signal SRS, a type of coherent transmission between the SRS ports, and a working state of the antenna panel.
Solution 4. The electronic apparatus according to Solution 3, wherein
the type of coherent transmission includes one of non-coherent transmission, partially-coherent transmission, and fully-coherent transmission.
Solution 5. The electronic apparatus according to Solution 3 or 4, wherein
the working state includes one of a state of the antenna panel supporting only downlink reception, a state of the antenna panel supporting downlink reception and uplink transmission, and the antenna panel being in an idle state.
Solution 6. The electronic apparatus according to any one of claims 3 to 5, wherein
the configuration information further includes latency information of the antenna panel.
Solution 7. The managing electronic apparatus according to Solution 6, wherein
the latency information includes activation latency and selection latency of the antenna panel,
the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and
the selection latency includes latency generated between performing uplink scheduling by the network side equipment and performing uplink transmission by the electronic apparatus.
Solution 8. The electronic apparatus according to any one of claims 3 to 7, wherein
the configuration information further includes a flag indicating whether the antenna panel supports at least one of uplink timing advance, uplink Doppler shift pre-compensation, and uplink power control independent of other antenna panels.
Solution 9. The electronic apparatus according to any one of claims 1 to 8, wherein the configuration information is set by the network side equipment for each antenna panel respectively, so that different antenna panels do not have the same configuration information.
Solution 10. The electronic apparatus according to any one of claims 1 to 8, wherein the configuration information is selected from a configuration information pool set by the network side equipment for the plurality of antenna panels, so that different antenna panels with the same mode share the same configuration information.
Solution 11. The electronic apparatus according to Solution 9 or 10, wherein each antenna panel corresponds to at least one piece of configuration information, and each of the at least one piece of configuration information corresponds to one mode of the antenna panel respectively.
Solution 12. The electronic apparatus according to any one of claims 1 to 11, wherein the downlink reference signal includes a channel state information reference signal CSI-RS or a synchronization signal block SSB.
Solution 13. The electronic apparatus according to Solution 12, wherein
the processing circuitry is configured to receive at least one downlink reference signal from the network side equipment, and
the processing circuitry is configured to report, in beam reporting, a configuration information ID of configuration information of each antenna panel that is not in an idle state, a downlink reference signal indication of the antenna panel for the at least one downlink reference signal, and a channel quality measurement result of the antenna panel on a downlink reference signal corresponding to the downlink reference signal indication, to the network side equipment.
Solution 14. The electronic apparatus according to Solution 13, wherein the processing circuitry is configured to, for each antenna panel that is not in an idle state:
obtain a channel quality measurement result of the antenna panel on the received at least one downlink reference signal, and
report the downlink reference signal indication for a downlink reference signal with a maximum channel quality measurement result.
Solution 15. The electronic apparatus according to Solution 13 or 14, wherein the channel quality measurement result includes L1-RSRP or L1-SINR.
Solution 16. The electronic apparatus according to any one of claims 13 to 15, wherein the processing circuitry is configured to determine an antenna panel associated with a downlink reference signal indication selected by the network side equipment, to perform uplink transmission with the antenna panel.
Solution 17. The electronic apparatus according to Solution 3, wherein the processing circuitry is configured to report, upon initial access of the device to the network side equipment, mode information related to configuration information of each antenna panel to the network side equipment, for the network side equipment to set the configuration information based on the mode information.
Solution 18. The electronic apparatus according to Solution 17, wherein the mode information includes the number of SRS ports of the antenna panel, a type of coherent transmission between the SRS ports, and a working state of the antenna panel.
Solution 19. The electronic apparatus according to Solution 18, wherein
the type of coherent transmission includes one of non-coherent transmission, partially-coherent transmission, and fully-coherent transmission.
Solution 20. The electronic apparatus according to either of Solutions 18 to 19, wherein
the working state includes one of a state of the antenna panel supporting only downlink reception, a state of the antenna panel supporting downlink reception and uplink transmission, and the antenna panel being in an idle state.
Solution 21. The electronic apparatus according to any one of Solutions 18 to 20, wherein
the mode information further includes latency information of the antenna panel.
Solution 22. The electronic apparatus according to Solution 21, wherein
the latency information includes activation latency and selection latency of the antenna panel,
the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and
the selection latency includes latency generated between performing uplink scheduling by the network side equipment and performing uplink transmission by the electronic apparatus.
Solution 23. The electronic apparatus according to any one of Solutions 18 to 22, wherein
the mode information further includes a flag indicating whether the antenna panel supports at least one of uplink timing advance, uplink Doppler shift pre-compensation, and uplink power control independent of other antenna panels.
Solution 24. The electronic apparatus according to any one of Solutions 1 to 7, wherein the processing circuitry is configured to report, for at least one antenna panel of the plurality of antenna panels, a configuration information ID of configuration information, power margin, maximum transmit power, and maximum allowable exposure of the at least one antenna panel.
Solution 25. The electronic apparatus according to Solution 24, the processing circuitry is configured to perform the reporting for the at least one antenna panel through a media access control element MAC CE.
Solution 26. The electronic apparatus according to any one of Solutions 1 to 7, wherein the processing circuitry is configured to:
report, to the network side equipment, that at least one antenna panel of the plurality of antenna panels supports uplink Doppler frequency shift pre-compensation independent of other antenna panels;
receive configuration information of supporting uplink Doppler frequency shift pre-compensation of the at least one antenna panel independent of the other antenna panels, which is set by the network side equipment; and
for the at least one antenna panel, estimate a downlink Doppler frequency shift by measuring a downlink time reference signal, and perform uplink Doppler frequency shift pre-compensation based on the estimated downlink Doppler frequency shift.
Solution 27. The electronic apparatus according to any one of Solutions 1 to 7, wherein the processing circuitry is configured to:
report, to the network side equipment, that at least one antenna panel of the plurality of antenna panels supports uplink timing advance independent of other antenna panels;
receive configuration information of supporting uplink timing advance of the at least one antenna panel independent of the other antenna panels, which is set by the network side equipment; and
receive, from the network side equipment, a configuration information ID of the configuration information, an uplink timing advance command, and an ID of a timing advance group of the at least one antenna panel.
Solution 28. The electronic apparatus according to any one of Solutions 1 to 7, wherein the processing circuitry is configured to:
report, to the network side equipment, that at least one antenna panel of the plurality of antenna panels supports uplink power control independent of other antenna panels;
receive configuration information of supporting uplink power control of the at least one antenna panel independent of the other antenna panels, which is set by the network side equipment; and
based on a configuration information ID of the configuration information of the at least one antenna panel and a power control command corresponding to the at least one antenna panel received from the network side equipment, for the network side equipment to perform uplink power control.
Solution 29. The electronic apparatus according to Solution 28, wherein
the power control command includes transmission power control commands of a physical uplink control channel PUCCH and a physical uplink shared channel PUSCH; and
the processing circuitry is configured to receive the configuration information ID and the power control commands from the network side equipment via a downlink control information DCI format.
Solution 30. The electronic apparatus according to Solution 28, wherein
the power control command includes a sounding reference signal SRS power control command; and
the processing circuitry is configured to receive the configuration information ID and the power control commands from the network side equipment via a downlink control information DCI format.
Solution 31. An electronic apparatus for wireless communications, comprising:
processing circuitry configured to set, for user equipment within coverage of a device related to the electronic apparatus, configuration information for each of a plurality of antenna panels of the user equipment,
wherein the configuration information is used to establish an association between each antenna panel and a downlink reference signal, for the electronic apparatus to select an antenna panel for uplink transmission from the plurality of antenna panels based on the association.
Solution 32. The electronic apparatus according to Solution 31, wherein the processing circuitry is configured to set the configuration information through radio resource control RRC signaling.
Solution 33. The electronic apparatus according to Solution 31 or 32, wherein
the configuration information includes configuration information ID, the number of SRS ports of the antenna panel capable of emitting a sounding reference signal SRS, a type of coherent transmission between the SRS ports, and a working state of the antenna panel.
Solution 34. The electronic apparatus according to Solution 33, wherein
the type of coherent transmission includes one of non-coherent transmission, partially-coherent transmission, and fully-coherent transmission.
Solution 35. The electronic apparatus according to Solution 33 or 34, wherein
the working state includes one of a state of the antenna panel supporting only downlink reception, a state of the antenna panel supporting downlink reception and uplink transmission, and the antenna panel being in an idle state.
Solution 36. The electronic apparatus according to any one of Solutions 33 to 35, wherein
the configuration information further includes latency information of the antenna panel.
Solution 37. The managing electronic apparatus according to Solution 36, wherein
the latency information includes activation latency and selection latency of the antenna panel,
the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and
the selection latency includes latency generated between performing uplink scheduling by the network side equipment and performing uplink transmission by the electronic apparatus.
Solution 38. The electronic apparatus according to any one of Solutions 33 to 37, wherein
the configuration information further includes a flag indicating whether the antenna panel supports at least one of uplink timing advance, uplink Doppler shift pre-compensation, and uplink power control independent of other antenna panels.
Solution 39. The electronic apparatus according to any one of Solutions 31 to 38, wherein the configuration information is set by the electronic apparatus for each antenna panel respectively, so that different antenna panels do not have the same configuration information.
Solution 40. The electronic apparatus according to any one of Solutions 31 to 38, wherein the configuration information is selected from a configuration information pool set by the electronic apparatus for the plurality of antenna panels, so that different antenna panels with the same mode share the same configuration information.
Solution 41. The electronic apparatus according to Solution 39 or 40, wherein each antenna panel corresponds to at least one piece of configuration information, and each of the at least one piece of configuration information corresponds to one mode of the antenna panel respectively.
Solution 42. The electronic apparatus according to any one of Solutions 31 to 41, wherein the downlink reference signal includes a channel state information reference signal CSI-RS or a synchronization signal block SSB.
Solution 43. The electronic apparatus according to Solution 42, wherein
the processing circuitry is configured to send at least one downlink reference signal to user equipment, and
the processing circuitry is configured to receive, in beam reporting, a configuration information ID of configuration information of each antenna panel that is not in an idle state, a downlink reference signal indication of the antenna panel for the at least one downlink reference signal, and a channel quality measurement result of the antenna panel on a downlink reference signal corresponding to the downlink reference signal indication, from the user equipment.
Solution 44. The electronic apparatus according to Solution 43, wherein a channel quality measurement result on the downlink reference signal corresponding to the downlink reference signal indication is a maximum value among channel quality measurement results of the antenna panel on the received at least one downlink reference signal.
Solution 45. The electronic apparatus according to Solution 43 or 44, wherein the channel quality measurement result includes L1-RSRP or L1-SINR.
Solution 46. The electronic apparatus according to any one of Solutions 43 to 45, wherein the processing circuitry is configured to perform selection for received downlink reference signal indications, and to use an antenna panel associated with the selected downlink reference signal indication as the antenna panel for uplink transmission.
Solution 47. The electronic apparatus according to Solution 33, wherein the processing circuitry is configured to receive, upon initial access of the user equipment to the device related to the electronic apparatus, mode information related to configuration information of each antenna panel from the user equipment, for the electronic apparatus to set the configuration information based on the mode information.
Solution 48. The electronic apparatus according to Solution 47, wherein the mode information includes the number of SRS ports of the antenna panel, a type of coherent transmission between the SRS ports, and a working state of the antenna panel.
Solution 49. The electronic apparatus according to Solution 48, wherein
the type of coherent transmission includes one of non-coherent transmission, partially-coherent transmission, and fully-coherent transmission.
Solution 50. The electronic apparatus according to either of Solutions 48 to 49, wherein
the working state includes one of a state of the antenna panel supporting only downlink reception, a state of the antenna panel supporting downlink reception and uplink transmission, and the antenna panel being in an idle state.
Solution 51. The electronic apparatus according to any one of Solutions 48 to 50, wherein the mode information further includes latency information of the antenna panel.
Solution 52. The electronic apparatus according to Solution 51, wherein
the latency information includes activation latency and selection latency of the antenna panel,
the activation latency includes at least one of latency generated in processes in which the antenna panel switches from an idle state to a state of supporting only downlink reception, switches from the idle state to a state of supporting downlink reception and uplink transmission, switches from the state of supporting only downlink reception to the state of supporting downlink reception and uplink transmission, and switches from the state of supporting downlink reception and uplink transmission to the state of supporting only downlink reception, and
the selection latency includes latency generated between performing uplink scheduling by the network side equipment and performing uplink transmission by the electronic apparatus.
Solution 53. The electronic apparatus according to any one of Solutions 48 to 52, wherein
the mode information further includes a flag indicating whether the antenna panel supports at least one ofuplink timing advance, uplink Doppler shift pre-compensation, and uplink power control independent of other antenna panels.
Solution 54. The electronic apparatus according to any one of Solutions 31 to 37, wherein the processing circuitry is configured to receive, from at least one antenna panel of the plurality of antenna panels, a configuration information ID of configuration information, power margin, maximum transmit power, and maximum allowable exposure of the at least one antenna panel.
Solution 55. The electronic apparatus according to Solution 54, the processing circuitry is configured to perform the receiving for the at least one antenna panel through a media access control element MAC CE.
Solution 56. The electronic apparatus according to any one of Solutions 31 to 37, wherein the processing circuitry is configured to:
receive mode information from the user equipment, the mode information including that at least one antenna panel of the plurality of antenna panels supports uplink Doppler frequency shift pre-compensation independent of other antenna panels; and
set configuration information of supporting uplink Doppler frequency shift pre-compensation of the at least one antenna panel independent of the other antenna panels, for the at least one antenna panel to perform uplink Doppler frequency shift pre-compensation.
Solution 57. The electronic apparatus according to any one of Solutions 31 to 37, wherein the processing circuitry is configured to:
receive mode information from the user equipment, the mode information including that at least one antenna panel of the plurality of antenna panels supports uplink timing advance independent of other antenna panels;
set configuration information of supporting uplink timing advance of the at least one antenna panel independent of the other antenna panels; and
send a configuration information ID of the configuration information, an uplink timing advance command, and an ID of the timing advance group of the at least one antenna panel to the user equipment.
Solution 58. The electronic apparatus according to any one of Solutions 31 to 37, wherein the processing circuitry is configured to:
receive mode information from the user equipment, the mode information including that at least one antenna panel of the plurality of antenna panels supports uplink power control independent of other antenna panels;
set configuration information of supporting uplink power control of the at least one antenna panel independent of the other antenna panels; and
send a configuration information ID of the configuration information of the at least one antenna panel, and a power control command corresponding to the at least one antenna panel, to the user equipment to perform uplink power control.
Solution 59. The electronic apparatus according to Solution 58, wherein
the power control command includes transmission power control commands of a physical uplink control channel PUCCH and a physical uplink shared channel PUSCH; and
the processing circuitry is configured to send the configuration information ID and the power control commands via a downlink control information DCI format.
Solution 60. The electronic apparatus according to Solution 58, wherein
the power control command includes a sounding reference signal SRS power control command; and
the processing circuitry is configured to send the configuration information ID and the power control commands via a downlink control information DCI format.
Solution 61. A method for wireless communications, comprising:
receiving configuration information set by network side equipment serving a device related to the electronic apparatus for each of a plurality of antenna panels of the electronic apparatus,
wherein the configuration information is used to establish an association between each antenna panel and a downlink reference signal, for the network side equipment to select an antenna panel for uplink transmission from the plurality of antenna panels based on the association.
Solution 62. A method for wireless communications, comprising:
setting, for user equipment within coverage of network side equipment, configuration information for each of a plurality of antenna panels of the user equipment,
wherein the configuration information is used to establish an association between each antenna panel and a downlink reference signal, for the network side equipment to select an antenna panel for uplink transmission from the plurality of antenna panels based on the association.
Solution 63. A computer-readable storage medium having stored thereon computer executable instructions that, when executed, execute the method for wireless communications according to Solution 61 or 62.

1. An electronic apparatus for wireless communications comprising:
at least one processor; and
at least one memory including computer program code, where the at least one memory and the computer program code are configured, with the at least one processor, to cause the electronic apparatus to at least:
receive configuration information set by network side equipment serving a device related to the electronic apparatus for each of a plurality of antenna panels of the electronic apparatus,
wherein the configuration information is used to establish an association between each antenna panel and a downlink reference signal, for the network side equipment to select an antenna panel for uplink transmission from the plurality of antenna panels based on the association.

2. The electronic apparatus according to claim 1, wherein the at least one memory and the computer program code are configured, with the at least one processor, to cause the electronic apparatus to receive the configuration information from the network side equipment through radio resource control RRC signaling.

3. The electronic apparatus according to claim 1, wherein
the configuration information includes configuration information ID, the number of SRS ports of the antenna panel capable of emitting a sounding reference signal SRS, a type of coherent transmission between the SRS ports, and a working state of the antenna panel.

4. The electronic apparatus according to claim 3, wherein
the type of coherent transmission includes one of non-coherent transmission, partially-coherent transmission, and fully-coherent transmission,
the working state includes one of a state of the antenna panel supporting only downlink reception, a state of the antenna panel supporting downlink reception and uplink transmission, and the antenna panel being in an idle state.

5. (canceled)

6. The electronic apparatus according to claim 3, wherein
the configuration information further includes latency information of the antenna panel.

7. (canceled)

8. The electronic apparatus according to claim 3, wherein
the configuration information further includes a flag indicating whether the antenna panel supports at least one of uplink timing advance, uplink Doppler shift pre-compensation, and uplink power control independent of other antenna panels.

9. The electronic apparatus according to claim 1, wherein the configuration information is set by the network side equipment for each antenna panel respectively, so that different antenna panels do not have the same configuration information, or
wherein the configuration information is selected from a configuration information pool set by the network side equipment for the plurality of antenna panels, so that different antenna panels with the same mode share the same configuration information.

10. (canceled)

11. The electronic apparatus according to claim 9, wherein each antenna panel corresponds to at least one piece of configuration information, and each of the at least one piece of configuration information corresponds to one mode of the antenna panel respectively.

12. The electronic apparatus according to claim 1, wherein the downlink reference signal includes a channel state information reference signal CSI-RS or a synchronization signal block SSB.

13. The electronic apparatus according to claim 12, wherein
the at least one memory and the computer program code are configured, with the at least one processor, to cause the electronic apparatus to receive at least one downlink reference signal from the network side equipment, and
the at least one memory and the computer program code are configured, with the at least one processor, to cause the electronic apparatus to report, in beam reporting, a configuration information ID of configuration information of each antenna panel that is not in an idle state, a downlink reference signal indication of the antenna panel for the at least one downlink reference signal, and a channel quality measurement result of the antenna panel on a downlink reference signal corresponding to the downlink reference signal indication, to the network side equipment.

14. The electronic apparatus according to claim 13, wherein the at least one memory and the computer program code are configured, with the at least one processor, to cause the electronic apparatus to, for each antenna panel that is not in an idle state:
obtain a channel quality measurement result of the antenna panel on the received at least one downlink reference signal, and
report the downlink reference signal indication for a downlink reference signal with a maximum channel quality measurement result.

15. The electronic apparatus according to claim 13, wherein the channel quality measurement result includes L1-RSRP or L1-SINR.

16. The electronic apparatus according to claim 13, wherein the at least one memory and the computer program code are configured, with the at least one processor, to cause the electronic apparatus to determine an antenna panel associated with a downlink reference signal indication selected by the network side equipment, to perform uplink transmission with the antenna panel.

17. The electronic apparatus according to claim 3, wherein the at least one memory and the computer program code are configured, with the at least one processor, to cause the electronic apparatus to report, upon initial access of the device to the network side equipment, mode information related to configuration information of each antenna panel to the network side equipment, for the network side equipment to set the configuration information based on the mode information.

18.-23. (canceled)

24. The electronic apparatus according to claim 1, wherein the at least one memory and the computer program code are configured, with the at least one processor, to cause the electronic apparatus to report, for at least one antenna panel of the plurality of antenna panels, a configuration information ID of configuration information, power margin, maximum transmit power, and maximum allowable exposure of the at least one antenna panel.

25. The electronic apparatus according to claim 24, wherein the at least one memory and the computer program code are configured, with the at least one processor, to cause the electronic apparatus to perform the reporting for the at least one antenna panel through a media access control element MAC CE.

26. The electronic apparatus according to claim 1, wherein the at least one memory and the computer program code are configured, with the at least one processor, to cause the electronic apparatus to:
report, to the network side equipment, that at least one antenna panel of the plurality of antenna panels supports uplink Doppler frequency shift pre-compensation independent of other antenna panels;
receive configuration information of supporting uplink Doppler frequency shift pre-compensation of the at least one antenna panel independent of the other antenna panels, which is set by the network side equipment; and
for the at least one antenna panel, estimate a downlink Doppler frequency shift by measuring a downlink time reference signal, and perform uplink Doppler frequency shift pre-compensation based on the estimated downlink Doppler frequency shift.

27. The electronic apparatus according to claim 1, wherein the at least one memory and the computer program code are configured, with the at least one processor, to cause the electronic apparatus to:
report, to the network side equipment, that at least one antenna panel of the plurality of antenna panels supports uplink timing advance independent of other antenna panels;
receive configuration information of supporting uplink timing advance of the at least one antenna panel independent of the other antenna panels, which is set by the network side equipment; and
receive, from the network side equipment, a configuration information ID of the configuration information, an uplink timing advance command, and an ID of a timing advance group of the at least one antenna panel.

28.-30. (canceled)

31. An electronic apparatus for wireless communications comprising:
at least one processor; and
at least one memory including computer program code, where the at least one memory and the computer program code are configured, with the at least one processor, to cause the electronic apparatus to at least:
set, for user equipment within coverage of a device related to the electronic apparatus, configuration information for each of a plurality of antenna panels of the user equipment,
wherein the configuration information is used to establish an association between each antenna panel and a downlink reference signal, for the electronic apparatus to select an antenna panel for uplink transmission from the plurality of antenna panels based on the association.

32.-60. (canceled)

61. A method for wireless communications, comprising:
receiving configuration information set by network side equipment serving a device related to the electronic apparatus for each of a plurality of antenna panels of the electronic apparatus,
wherein the configuration information is used to establish an association between each antenna panel and a downlink reference signal, for the network side equipment to select an antenna panel for uplink transmission from the plurality of antenna panels based on the association.

62.-63. (canceled)
